(19) United States
(12) Patent Application Publication
(10) Pub. No.: US 2007/0200657 A1
(43) Pub. Date: Aug. 30, 2007

(54) Thermal fuse varistor assembly with an insulating glass passivation layer

(76) Inventors: Shang-Chih Tsai, Taipei (TW); Chang-Chin Huang, Taipei (TW); Chin-Lung Tsen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/362,859

(22) Filed: Feb. 28, 2006

(51) Int. Cl. H01C 7/10

(52) U.S. Cl. 338/21

(57) ABSTRACT

A thermal fuse varistor assembly with an insulating glass passivation layer has a varistor, electrodes, an insulating glass passivation layer, a lead assembly, a fuse, an insulating glass passivation glue and a coating. The varistor has a top surface and a bottom surface. The electrodes are respectively applied to the varistor. The insulating glass passivation layer is applied to the whole electrode on the top surface of the varistor The lead assembly is connected to the electrodes and has a first lead, a second lead and a third lead. The first lead is connected to the electrode on the bottom surface of the varistor. The second lead is connected to the electrode on the top surface of the varistor. The third lead is located on the insulating glass passivation layer. The fuse is connected between the electrode on the top surface of the varistor and the third lead.

### BACKGROUND OF THE INVENTION

1. Field of the Invention

The present invention relates to a varistor assembly, and more particularly to a varistor assembly with insulating glass passivation layer to prevent the fuse in varistor assembly from reconnection again.

2. Description of Related Art

A varistor is a surge protector connected directly across an A/C input in a circuit. When a power surge or voltage spike is sensed, the varistor generates an instant shunt path for the power surge or voltage spike. Accordingly, a protective effect is provided to the circuit by the varistor. However, the shunt path is a short circuit so the varistor is easily damaged or weakened resulting from often taking high level temperature.

A layer of thermal fusible material or a column of solder is mounted on the varistor and is connected between an electrode of the varistor and a lead spaced-apart to prevent damage or weakness of the varistor. In U.S. Pat. No. 6,636,403, an insulation disc of alumina material is further applied to the electrode of the varistor, and part of the thermal fuse and the lead are attached to the insulation disc. When the thermal fusible material or the column of solder overheats, the thermal fusible material or the column of solder melts to form an open circuit to break the connection between the electrode of the varistor and the lead spaced-apart and the insulation disc causes an insulating gap rapidly created by melting thermal fusible material or solder to insulate the electrode from connecting to the lead.

However, the temperature of the varistor still remains at a high level and the thermal fusible material may still remain melting after the thermal fusible material or solder melts. The melting thermal fusible material or solder may flow to reconnect the electrode of the varistor and the lead because the greater part of the electrode is still exposed.

To overcome the shortcomings, the present invention provides a varistor assembly with a thermal protection capability to mitigate or obviate the aforementioned problems.

### SUMMARY OF THE INVENTION

The main objective of the invention is to provide a thermal fuse varistor assembly with an insulating glass passivation layer for preventing the varistor from reconnecting in the event of the fuse open.

The varistor assembly in accordance with the present invention comprises a varistor, electrodes, an insulating glass passivation layer, a lead assembly, a fuse, an insulating glue and a coating. The varistor has a top surface and a bottom surface. The electrodes are respectively mounted on the top surface and bottom surface of the varistor. The insulating glass passivation layer is applied to the whole electrode on the top surface of the varistor and has an aperture with a depth. The lead assembly is connected to the electrodes and comprises a first lead, a second lead and a third lead. The first lead is connected to the electrode on the bottom surface of the varistor. The second lead is connected to the electrode on the top surface of the varistor. The third lead is located on the insulating glass passivation layer. The fuse is connected between the electrode on the top surface of the varistor and the third lead. The insulating glue is mounted around and encloses the fuse. The coating is coated on the varistor and encloses the varistor, electrodes, the insulating glass passivation layer, part of the lead assembly, the fuse and the insulating glue.

Other objectives, advantages and novel features of the invention will become more apparent from the following detailed description when taken in conjunction with the accompanying drawings.

### BRIEF DESCRIPTION OF THE DRAWINGS

FIG. 1 is a front view in partial section of a varistor assembly in accordance of the present invention; and

FIG. 2 is a side view in partial section of the varistor assembly in FIG. 1.

### DETAILED DESCRIPTION OF PREFERRED EMBODIMENT

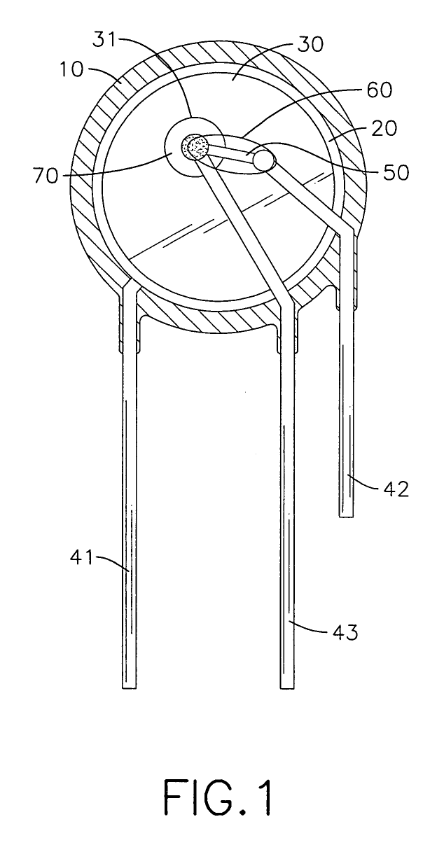

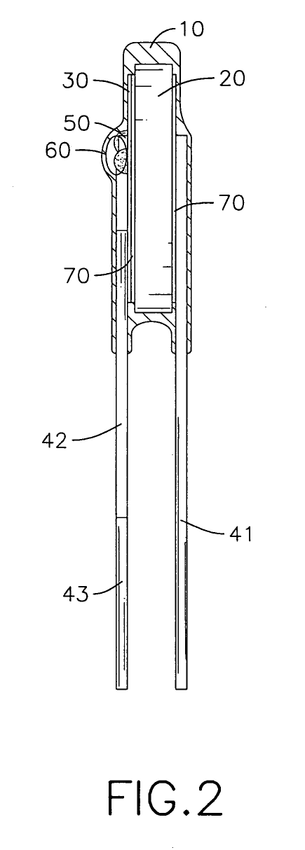

With reference to FIGS. 1 and 2, a thermal fuse varistor assembly with an insulating glass passivation layer in accordance with the present invention comprises a varistor (20), electrodes (70), an insulating glass passivation layer (30), a lead assembly, a fuse (50), an insulating glue (60) and a coating (10).

The varistor (20) has a top surface and a bottom surface.

The electrodes (70) are made of silver and are respectively applied to the top surface and bottom surface of the varistor (20) by firing.

The insulating glass passivation layer (30) may be made of glass, is applied to the whole electrode (70) on the top surface of the varistor (20) and has an aperture (31). The aperture (31) exposes the electrode (70) on the top surface of the varistor (20).

The lead assembly is connected to the electrodes (70) and comprises a first lead (41), a second lead (43) and a third lead (42). The first lead (41) is securely connected o the electrode (70) on the bottom surface of the varistor (20). The second lead (43) is securely connected to the electrode (70) on the top surface of the varistor (20). The third lead (42) is securely located on the insulating glass passivation layer (30).

The fuse (50) is located on the insulating glass passivation layer (30) and is connected between the electrode (70) on the top surface of the varistor (20) and the third lead (42).

The insulating glue (60) may be hot melt glue, is mounted around, encloses and wraps the fuse (50) to insulate the fuse (50).

The coating (10) may be made of epoxy resin or phenolic resin, is coated on the varistor (20) and encloses the varistor (20), electrodes (70), the insulating glass passivation layer (30), part of the lead assembly, the fuse (50) and the insulating glue (60).

When the temperature of the varistor (20) continuously rises to a predetermined level, the fuse (50) melts to break the connection between the electrode (70) on the top surface of the varistor (20) and the third lead (42). With the application of the insulation glass passivation layer (30), the melting fuse (50) or the melted fuse (50) will not connect the electrode (70) on the top surface of the varistor (20) and the third lead (42).

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A thermal fuse varistor assembly with an insulating glass passivation layer comprising:
a varistor having a top surface and a bottom surface;
electrodes respectively applied to the top surface and bottom surface of the varistor;
an insulating glass passivation layer applied to the whole electrode on the top surface of the varistor and having
an aperture corresponding to and holding the electrode on the top surface of the varistor to make the electrode on the top surface of the varistor to be exposed from the aperture;
a lead assembly connected to the electrodes and comprising
a first lead connected to the electrode on the bottom surface of the varistor;
a second lead connected to the electrode on the top surface of the varistor; and
a third lead located on the insulating glass passivation layer;
a fuse located on the insulating glass passivation layer and connected between the electrode on the top surface of the varistor and the third lead;
an insulating glue mounted around and enclosing the fuse; and
a coating coated on the varistor and enclosing the varistor, electrodes, the insulating glass passivation layer, part of the lead assembly, the fuse and the insulating glue.

2. The varistor assembly as claimed in claim 1, wherein electrodes are made of silver.

3. The varistor assembly as claimed in claim 1, wherein the coating is made of epoxy resin.

4. The varistor assembly as claimed in claim 1, wherein the coating is made of phenolic resin.

5. The varistor assembly as claimed in claim 1, wherein the insulating glass passivation layer is made of glass.

6. The varistor assembly as claimed in claim 1, wherein the insulating glue is hot melt glue.
